(19) United States
(12) Patent Application Publication
(10) Pub. No.: US 2005/0014909 A1
(43) Pub. Date: Jan. 20, 2005

(54) Compound containing epoxide and maleimide groups, cured resin prepared from said compound

(75) Inventors: Ying-Ling Liu, Taoyuan (TW); Yu-Jane Chen, Taoyuan (TW)

Correspondence Address: BACON & THOMAS, PLLC, 625 SLATERS LANE, FOURTH FLOOR, ALEXANDRIA, VA, 22314, US

(73) Assignee: CHUNG YUAN CHRISTIAN UNIVERSITY, Taoyuan (TW)

(21) Appl. No.: 10/621,520

(22) Filed: Jul. 18, 2003

(51) Int. Cl. C08G 59/02

(52) U.S. Cl. 525/523

(57) ABSTRACT

A compound having the following structure is disclosed, which has an epoxide group and a maleimide group and can be reacted in a curing reaction to prepared a cured thermoset resin: 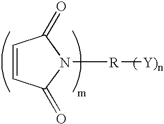
wherein m and n independently are an integer equal to or greater than one, R is a residue having at least one carbon and having a valence equal to a sum of m and n, and Y is

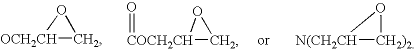

### FIELD OF THE INVENTION

The present invention relates to a compound having an epoxide group and a maleimide group, which can be used to prepare a cured thermoset resin having a high glass transition temperature (Tg) and excellent thermal stability.

### BACKGROUND OF THE INVENTION

Epoxy resins have superior properties such as low curing shrinkage, good chemical and acid/alkali resistance, easy to be processed, excellent electrical insulation property, and high adhesive strength, which render epoxy resins being versatile in applications. In particular, epoxy resins become one of the most important materials in the fabrication of electronic devices as a binder of printed circuit boards and an encapsulation material of electronic devices. In the recent development of thinner, lighter and more compact electronic devices, and advanced semiconductor fabrication processes, epoxy resins having higher thermal stability, Tg and dimensional stability, and lower dielectric constant are desired. However, these requirements are difficult to be met due to the structure per se of epoxy resins. As a result, materials other than epoxy resin have been used in the application fields pertaining to the epoxy resin. These substitution materials are not very successful in view of their higher prices and certain manufacturing factors. Moreover, some of the superior properties of the epoxy resins are sacrificed in these substitution materials.

Polyimides also have superior properties such as high thermal stability, high Tg, good dimensional stability and low dielectric constant, and have been widely utilized in the electronic industries. However, polyimides suffer a defect of poor workability. Maleimide resin can be thermally cured to form a polyimide, which is named as an additive type polyimide polymer to distinguish from the conventional long-chain polyimide formed by condensation. Maleimide resin has gained more applications in recent years due to its thermal stability and relatively easier workability. On the other hand maleimide resin will not release volatile small compounds in the course of hardening, and can be processed similarly as the epoxy resin, which are advantages not seen in the conventional long-chain polyimide formed by condensation. However, maleimide resin suffers some inherent defects such as an extremely high hardening temperature, poor solubility in organic solvents, high brittleness and expensive.

U.S. Pat. No. 5,310,830 discloses a heat-resistant resin composition by mixing a resin composing (A) and polyamine (B), followed by heating the mixture for the hardening, said composition (A) being prepared by heating a mixture of (a) a polymaleimide resin, (b) an epoxy resin having at least two epoxy groups and (c) a compound having one alcoholic or phenolic OH group and at least one epoxy group. The mixing of (a) to (c) often creates a problem in preparation and workability. Further, a compatible problem is also needed to be considered between the polymaleimide resin (a), the epoxy resin (b) and the compound (c).

### SUMMARY OF THE INVENTION

A primary objective of the present invention is to provide a compound having both the maleimide group and the epoxide group, which can be thermally cured to form a high performance hardened resin.

The above-mentioned objective of the present invention is achieved by using approaches of molecular design and chemical reactions. The compound synthesized according to the present invention has characteristics from both the maleimide group and epoxide group, and thus the hardened resin prepared from this compound will have superior properties contributed both by the maleimide group and the epoxide group such as low curing shrinkage, good chemical and acid/alkali resistance, easy to be processed, excellent electrical insulation property, high adhesive strength, high dimensional stability, high Tg, and high thermal stability. The compound and the hardened resin of the present invention are suitable for preparing a composite material, and in particular in the fabrication of electronic devices as a binder of printed circuit boards and an encapsulation material of electronic devices.

### DETAILED DESCRIPTION OF THE INVENTION

The present invention discloses a compound having the following structure, which contains an epoxide group and a maleimide group and can be used to prepare a cured thermoset resin via a curing reaction: 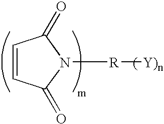
wherein m and n are integers not less than 1, R is a residue having at least one carbon and a valence equal to the sum of m and n, and Y is

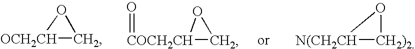

Preferably, R is an aromatic residue.

Preferably, R is a residue of benzene.

Preferably, m is 1, and n is 1 or 2.

Preferably, Y is

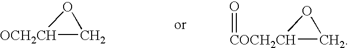

Preferably, the compound of the present invention has the following structure:

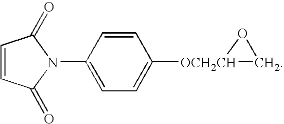

Preferably, the compound of the present invention has the following structure:

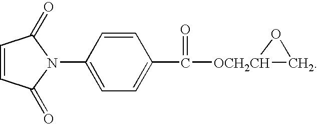

Preferably, the compound of the present invention has the following structure:

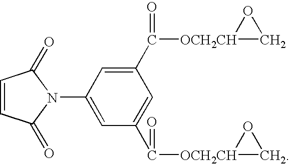

The compound of the present invention can be cured alone in said curing reaction, or together with an additional compound or an additional resin. Further, a curing agent may be used in said curing reaction. A suitable curing agent can be any known curing agents for the epoxy resin, including (but not limited to) amines, phenols, acids, anhydrides, amides. Said additional compound can be a compound comprising an epoxide group or maleimide group. Said additional resin can be an epoxy resin.

The present invention can be further understood with the following examples which are used for illustrative purposes and not for limiting the scope of the present invention. The reactions involved in the following examples are shown in the following scheme:

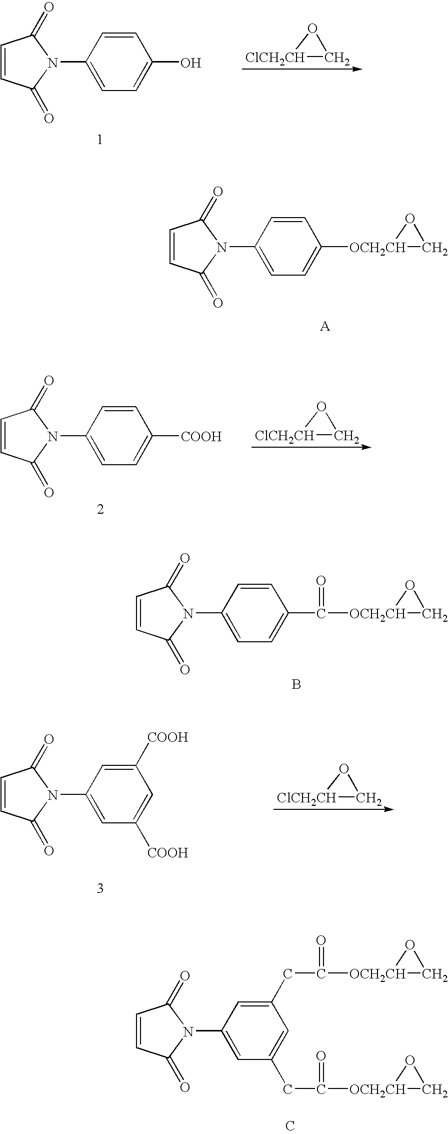

### EXAMPLE 1

### Synthesis of Compound A

In a 1L three-necked flask equipped with a temperature control device, a condensation tube and a stirrer, 40 g of 4-maleimidophenol 1 was dissolved in 400 ml of ethanol solution of potassium hydroxide (0.5 mol/L). To the resulting solution 200 g of epichlorohydrin was added while stirring under N₂ atmosphere. The stirring was continued for 48 hours at room temperature. The resulting reaction mixture was filtered, and the filtrate was washed with a saturated aqueous solution of sodium hydrogen carbonate and pure water. The washed organic phase was separated, and the organic solvent was dried by evaporation to obtain a product compound A (45 g).

### EXAMPLE 2

### Synthesis of Compound B

In a 1L three-necked flask equipped with a temperature control device, a condensation tube and a stirrer, 40 g of 4-maleimidobenzoic acid 2 was dissolved in 400 g of epichlorohydrin. To the resulting solution 2 g of phenyltriethylammonium chloride was added as a catalyst. The reaction was carried out at 60° C. under N₂ atmosphere for 4 hours with stirring. The resulting reaction mixture was filtered, and the filtrate was washed with a saturated aqueous solution of sodium hydrogen carbonate and pure water. The washed organic phase was separated, and the organic solvent was dried by evaporation to obtain a product compound B (46 g).

### EXAMPLE 3

### Synthesis of Compound C

In a 1L three-necked flask equipped with a temperature control device, a condensation tube and a stirrer, 40 g of 3-maleimido-1,5-benzoic diacid 3 was dissolved in 400 g of epichlorohydrin. To the resulting solution 2 g of phenyltriethylammonium chloride was added as a catalyst. The reaction was carried out at 60° C. under N₂ atmosphere for 4 hours with stirring. The resulting reaction mixture was filtered, and the filtrate was washed with a saturated aqueous solution of sodium hydrogen carbonate and pure water. The washed organic phase was separated, and the organic solvent was dried by evaporation to obtain a product compound C (52 g).

### EXAMPLE 4

### Preparation of Cured Resin A-1

20 g of compound A and 3.8 g of 4,4-diaminodipehnylmethane were dissolved in 50 mL of acetone with stirring. The solution was placed in an oven for curing after the organic solvent thereof had been evaporated at room temperature. The curing reaction was carried out at 120° C. for 2 hours, 160° C. for 2 hours, 190° C. for 2 hours and 210° C. for 2 hours in sequence to obtain a cured resin A-1.

### EXAMPLE 5

### Preparation of Cured Resin A-2

20 g of compound A and 1.0 g of dicyandiamide were dissolved in 50 mL of acetone with stirring. The solution was placed in an oven for curing after the organic solvent thereof had been evaporated at room temperature. The curing reaction was carried out at 120° C. for 2 hours, 160° C. for 2 hours, 190° C. for 2 hours and 210° C. for 2 hours in sequence to obtain a cured resin A-2.

The thermal properties of the cured resins A-1 and A-2 are listed in the following table:

| | Temperature of 5 | Glass transition temperature, | |
|---|---|---|---|
| Cured resin | wt % loss, (° C.)^{a} | Tg (° C.)^{b} | LOI^{c} |
| A-1 | 342 | 210 | 36.0 |
| A-2 | 363 | 219 | 38.5 |

^{a}Thermogravimetric analysis (TGA) conducted in N₂ with a healing rate of 10° C./min.
^{b}Measured by differential scanning calorimeter (DSC) with a heating rate of 20° C./min.
^{c}Limiting oxygen index (LOI) tested according to ASTM D-2863.

1. A compound having the following structure: 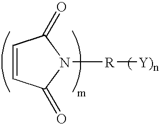
wherein m and n are integers not less than 1, R is a residue having at least one carbon and a valence equal to the sum of m and n, and Y is

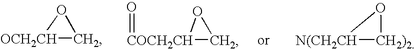

2. The compound as claimed in claim 1, wherein R is an aromatic residue.

3. The compound as claimed in claim 2, wherein R is a residue of benzene.

4. The compound as claimed in claim 1, wherein m is 1, and n is 1 or 2.

5. The compound as claimed in claim 1, wherein Y is

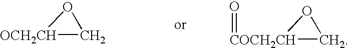

6. The compound as claimed in claim 1 having the following structure:

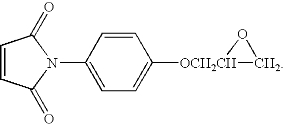

7. The compound as claimed in claim 1 having the following structure:

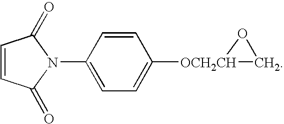

8. The compound as claimed in claim 1 having the following structure:

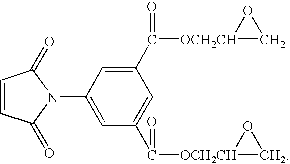

9. A cured thermoset resin prepared by curing a compound as claimed in claim 1.

10. A cured thermoset resin prepared by curing a compound as claimed in claim 1 together with an additional compound or an additional resin.

11. The cured thermoset resin as claimed in claim 9, wherein said curing is carried out in the presence of a curing agent.

12. The cured thermoset resin as claimed in claim 10, wherein said curing is carried out in the presence of a curing agent.
